(19) United States
(12) Patent Application Publication
(10) Pub. No.: US 2026/0366681 A1
(43) Pub. Date: Nov. 19, 2026

(54) COLOR-MIXING COLLECTING OPTICAL UNIT WITH IMPROVED FUNCTIONALITY

(71) Applicant: SWARCO FUTURIT VERKEHRSSIGNALSYSTEME GMBH, Perchtoldsdorf (AT)

(72) Inventor: Alexander OTTO, Göllersdorf (AT)

(21) Appl. No.: 19/515,401

(22) PCT Filed: Aug. 22, 2024
(86) PCT No.: PCT/EP2024/073609

§ 371 Date: Feb. 27, 2026

(30) Foreign Application Priority Data
Aug. 29, 2023 (EP) EP23194114

(51) Int. Cl. F21K 9/62; F21K 9/61; F21V 5/04; F21Y 113/13; G02B 19/00

(52) U.S. Cl. CPC F21K 9/62; F21K 9/61; F21V 5/041; G02B 19/0028; G02B 19/0066; F21Y 2113/13

(57) ABSTRACT

A full color-mixing optical unit with commercially available RGB-LEDs, for pixels of variable message road signs and message boards and other applications. The disclosed optical unit employs LED chips (R, G, B) having the same size and emission characteristics placed in a linear dense arrangement, so that color mixing is required in only the direction of the linear arrangement. The converging lens has a focal point on the exit surface in this linear direction but more freedom of design in the transverse direction thereto. The disclosed full color-mixing optical unit offers a previously unknown freedom in attainable light distribution, allowing for a more accurate adjustment of the light distribution to specification, and improved color mixing.

### TECHNICAL FIELD

The present disclosure relates to optical units for display panels, and more particularly to color-mixing collecting optical units that can be used for display panels as well as light sources for general and effect lighting purposes.

### BACKGROUND

The present disclosure relates to a color-mixing collecting optical unit which, on the one hand, can be used for full-color-capable pixels for outdoor display panels for the representation of graphics, images, and videos at relatively large distances, but on the other hand also as a full-color-capable light source for general and effect lighting purposes.

While such an application previously required the use of at least three individual optical units with monochromatic LEDs in the primary colors red, green, and blue for one pixel, so-called full-color or RGB LEDs have become established in the indoor sector, which as a rule contain three chips in the primary colors red, green, and blue in a common housing with a planar translucent encapsulation, wherein the luminous area of the semiconductors used is referred to here as the chip or chip dimensions. They are available in various sizes, so that high-resolution representations are also possible on smaller display panels. They emit their light without an optical unit in the form of a cosine radiator directly into the room and therefore exhibit a relatively low brightness of the display, but can be seen very well from close up and from a large observation range. They are not suitable as such for outdoor display panels, or only with considerable energy consumption and cooling effort as well as a seal, and their operation would be associated with high costs. By contrast, with a suitable collecting optical unit, both their focused brightness and the viewing angle restricted thereby would be completely sufficient and would correspond to relevant standards.

Unfortunately, simply placing a converging lens in front is not enough, because the unavoidable distance of the three chips from one another results in three non-congruent light cones, and thus neither the prescribed traffic colors nor the required uniformity are fulfilled; color spotting and color fringing would occur depending on the viewing angle, and the simple means for color mixing known to date cannot be used for reasons of cost and space.

After many years of trial and error, a simple and very efficient solution to this problem was finally presented with the international application WO 2012/068603, which quickly established itself on the market, for which reason patent protection was bitterly contested and called into question by competitors, albeit ultimately without success. The mode of operation explained in detail therein is indeed not easily comprehensible, but it provides an exceptionally good color-mixing and light-distribution result with a simple geometry, so that an equivalent alternative embodiment appears impossible as an evasion option for competitors.

However, the inventor has found a design option which does not infringe this application, offers an at least similar but also better adaptable and more diversely designable light distribution and, in the process, even improved color mixing, and also allows completely new and different light distributions and light solutions.

### SUMMARY

The present disclosure is directed to an optical unit for illuminated signs, display panels, and other sources of lighting. The disclosed optical unit is capable of full color reproduction with previously unknown flexibility in customizable completely new and different light distributions and light solutions.

In one example, the present disclosure is directed to a color-mixing collecting optical unit having a main axis, including an LED light source having a plurality of LED chips, where the LED chips are disposed in a linear arrangement and have substantially identical widths and substantially identical emission characteristics; a light guide having a light entry surface arranged directly in front of the LED light source that is configured to capture and transmit light emitted by the LED light source; and a converging lens succeeding the light guide having a mirror-polished lens dome. The light guide is delimited on each side by a pair of symmetrically-designed and mirror-polished reflection planes aligned perpendicular to the linear arrangement of LED chips so that a distance between the side reflection planes is constant or gradually increasing in a direction of the converging lens. The light guide is further delimited by a pair of mirror-polished connecting surfaces that are transverse to the pair of side reflection planes and that meet the side reflection planes forming sharp edges, and the ends of the side reflection planes define an exit surface of the light guide. The converging lens has a first focal point in cross-section in a direction of the linear arrangement of the LED chips, the first focal point being on the exit surface of the light guide; and the converging lens has either another distinct focal point, or no other distinct focal point, or a focal spot that is transverse to the first focal point; so that the mirror-polished lens dome represents a free-form surface.

The features, functions, and advantages of the disclosed color-mixing collecting optical units may be achieved independently in various embodiments of the present disclosure, or may be combined in yet other embodiments, further details of which can be seen with reference to the following description and drawings.

### BRIEF DESCRIPTION OF THE DRAWINGS

FIGS. 1A and 1B show the principle construction and the mode of operation of an exemplary optical unit according to the present disclosure in longitudinal and transverse views.

FIG. 2 shows suitable and unsuitable chip arrangements of LED light sources in top view.

FIG. 3 shows an exemplary embodiment of an optical unit according to the present disclosure in plan, front, and side views.

FIG. 4 depicts an exemplary representation of an optical unit according to the present disclosure with the light distribution it produces.

FIG. 5 depicts a simulated beam path in plan and elevation views with a representation of the achieved light distribution of the disclosed optical unit in three graphics.

FIG. 6 depicts the achieved light distributions of the individual chips in comparison.

FIG. 7 depicts another application of an optical unit of the present disclosure in plan and elevation views, with beam path and representation of the achieved light distribution likewise in three graphics.

FIG. 8 depicts an exemplary optical unit with two light bundles in elevation view.

FIG. 9 shows an exemplary angled optical unit in elevation view, with an achieved light distribution.

### DETAILED DESCRIPTION OF PREFERRED EMBODIMENTS

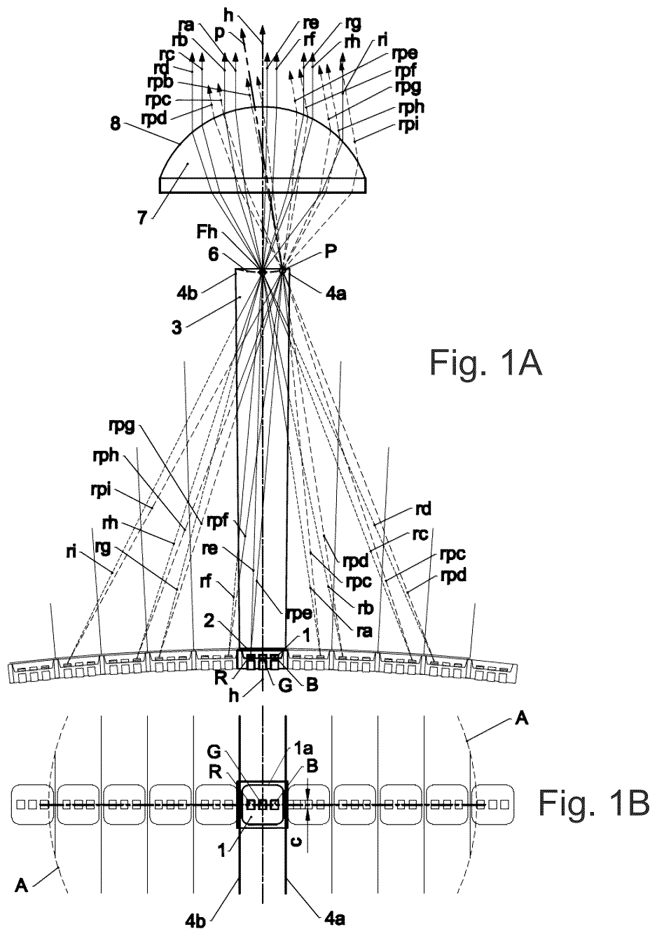

In its various embodiments, the optical system of the present disclosure refers to international application WO 2012/068603 (Swarco), also published as EP 2643717 B1 or PCT/AT2011/000468, which is to be regarded as state of the art and was reviewed in detail with regard to citations and objections and nearby known publications cited therein, which could also be cited here in exactly the same way, and which of course comes closest to the presently disclosed optical system. It represents an excellent color mixing for arbitrary crystal arrangements which, by means of a gapless multiple reflection at the mirror-polished planes of the light guide (FIG. 1), produce a uniformly brightly radiating exit surface (4) on which the focus (F) of the upstream converging lens (5) is located. The converging lens is therefore a correspondingly designed body of revolution.

The optical system of the present disclosure likewise uses an RGB or multicolor LED light source, which, however, must fulfill certain conditions regarding the arrangement, type, and size of the chips, which in reality only causes problems in exceptional cases. This results in a greater freedom of design for the color-mixing optical unit, which allows a more precise and thus more efficient, but also more diverse adaptation of the resulting light distribution and clearly differs from the known embodiment. It also has a light entry surface, a light guide, and a converging lens in the direction of the main light emission direction, but is characterized in that all chips of the LED light source are arranged linearly at a close distance, have identical width dimensions and emission characteristics, in that the light guide is delimited on both sides of the linear arrangement by symmetrically designed mirror-polished reflection planes aligned perpendicular thereto, the distance between which is constant or gradually increases in the direction of the converging lens and the ends of which define the exit surface, as well as being delimited with sharp edges transversely thereto by otherwise shaped mirror-polished connecting surfaces, and in that the converging lens has a focal point in cross-section in the direction of the linear arrangement which comes to lie on this exit surface of the light guide, and has another or no distinct focal point, or a focal spot transversely thereto, and thus the mirror-polished lens dome represents a free-form surface.

The dimension transverse to the linear arrangement is always understood here as the chip width (c). In other words: if the chips are positioned in a narrow linear arrangement and they have identical widths and identical emission characteristics, which is now the case for almost all RGB LEDs for video displays, it is sufficient to mix the different colors only in the direction of the linear arrangement, which is done by the reflection planes of the light guide arranged on both sides; however, no color mixing is necessary in the transverse direction. Thus, the connecting surfaces between the reflection planes of the light guide are released from the mixing-dependent design as reflection planes and can thus effect a more precisely adapted or different light distribution in this direction. Likewise, the converging lens contour necessary for the color mixing with a focal point on the light exit surface of the light guide is then also only necessary for the lens cross-section in this linear direction; transversely thereto, the converging lens can take an independent course, which mostly leads to the formation of lens geometries that appear oval, egg-shaped, or rod-shaped. The light distribution transverse to the linear chip arrangement then occurs through the interaction of the connecting surfaces with the converging lens embodiment in this direction. Because significantly more design parameters are present here than in the linear mixing direction by means of planes, more and new options for light distribution emerge therefrom compared to the known embodiment, in particular also for new applications yet to be developed.

A division into two systems that are only slightly dependent on one another thus takes place here, namely the color-mixing system in the linear direction with the two reflection planes and the associated focal point of the converging lens cross-section on the exit surface, and transversely thereto a fairly freely designable light-directing system consisting of connecting surfaces and an associated converging lens cross-section with a different focal point position or a focal length gradient, wherein these two lens cross-sections are perpendicular to one another and define a free-form surface according to mathematical rules and formulas, which closes the converging lens, for example by extruding one contour along the other and optionally subjecting it to further modifiers. The collecting effect as a necessary component of color mixing only has to be present in the linear direction; in the transverse direction, this is not necessary.

In the already known system, the light guide is delimited only by mirror-polished planes for all-round, high-quality color mixing (FIG. 1, independent claim, dependent claim 10), but in the system according to the present disclosure it is delimited by two opposing mirror-polished planes and more freely designable mirror-polished connecting surfaces, at least one of which is curved or bent, or else provided with a surface structure. The already known converging lens is geometrically a body of revolution with an optical focal point, also referred to as “imaging,” but the converging lens according to the present disclosure has a free-form geometry without such a uniformly defined focal point.

The requirements for light distribution and the design options for light guide and converging lens determine how the linear arrangement of the chips is to be oriented in the display product. For a standard traffic display panel, the linear arrangement in the horizontal direction is recommended because light distributions occurring in this case, which follow a cosine-like course, have proven themselves for a long time and are also suggested by the product standard EN 12966, and some embodiments for this must take the position of the sun into account. In the transverse direction, the light distribution is much more demanding, which can be better produced with the free design of the connecting surfaces. Therefore, in further descriptions, only a horizontal orientation is assumed in order to keep the descriptions of figures simple and understandable; however, this does not represent any restriction regarding the orientation of the disclosed apparatus in space—one need only think of a general use of the system in a full-color flashlight.

Transversely thereto, i.e., now in the vertical direction, a good light distribution appears as a halved cosine-like distribution, which should as far as possible be zero above the main emission direction, because with the usual high installation of the display panels no one can look at them from above anyway, and decreasing downwards from the main emission direction with maximum brightness. This would also nearly double the brightness or efficiency. Such a light distribution is inherently difficult to achieve but essential for this application, because it also significantly reduces the back-reflection behavior in incident sunlight, which, however, is not the subject of this application.

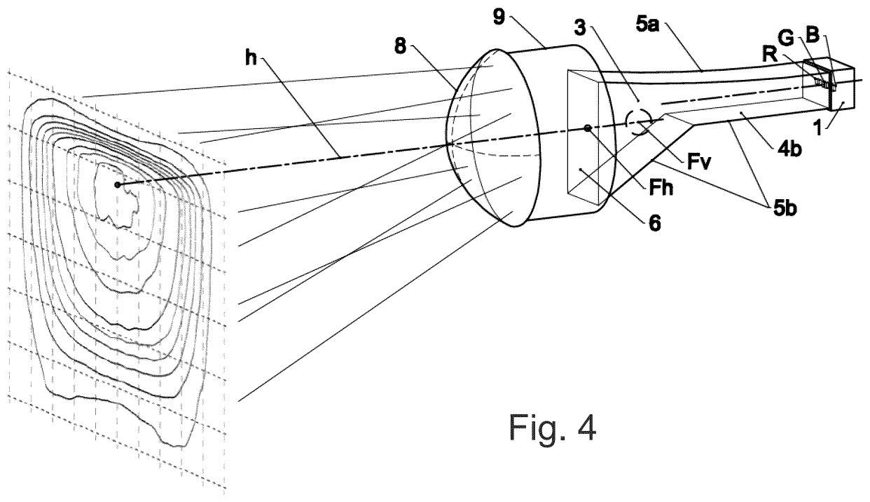

A property of the already known solution that is disruptive in this context is the upside-down projection of the light guide exit surface (4) to infinity by the so-called “imaging” property of the converging lens with its focal point on the exit surface; the primarily rectangular shape of this exit surface (4), which is equally bright everywhere, is therefore found in every light distribution variant and must be suitably positioned, concealed, supplemented, and also blurred by accompanying measures, which is difficult due to the narrow design specifications. This can be seen particularly well in FIG. 4 thereof, where the light distribution is produced by the rectangle formed by the exit surface (4), which is surrounded by outgoing light (9, 9a) by means of extended boundary planes (8, 8a) of the light guide (2). In this way, however, the design rule is violated in that the exit surface (4) and focus (F) are no longer located exactly at the end of the light guide and thus, due to incipient segregation towards the edge of the light distribution in the regions (9, 9a), a certain required blurring, but also a certain color change, occurs. The desired light distribution can therefore only be achieved through additions and small deviations from the geometric requirements of the color-mixing system and thus represents a compromise between color-mixing quality and desired light distribution.

In the application according to the present disclosure, on the other hand, the exit surface of the light guide is neither uniformly bright, nor is the converging lens imaging, nor are the reflection planes of the light guide extended beyond the exit surface. As a result, it exhibits both better mixing quality and greater design freedom or adaptability in the light distribution, which, however, is not immediately obvious and can only be determined by light simulation, as will now be set out and explained in detail.

In FIG. 1A, the color-mixing optical unit can be seen in longitudinal view. A flat-encapsulated LED light source 1 with three chips lying linearly next to one another in the primary colors red R, green G, and blue B sends its light into an entry surface 2 of a light guide 3 located directly in front thereof; this is refracted towards the perpendicular and passed on by a multiple lossless total internal reflection, not shown, at the side walls, which for this purpose are designed as mirror-polished planes 4a and 4b. The planes are arranged symmetrically to the optical axis, the main axis h of the optical unit, and either parallel to one another or at a slight angle with a gradually increasing distance from one another. Their ends define an exit surface 6 through which the light passes and enters the converging lens 7, where it strikes the lens dome 8 and is there again deflected.

In the following consideration, only the red chip R is assumed to be luminous. The lens dome 8 appears in this representation as a generatrix of a lens surface which deflects every light ray incident from outside parallel to the axial direction h to such an extent that it runs through a horizontal focal point Fh, which is located on the exit surface 6 and the main axis h and thus also conversely directs every red light ray ra, rb, rc . . . of the LED light source 1 that runs through this horizontal focal point Fh parallel to the main axis h. All light rays rpa, rpb, rpc . . . , which pass through an arbitrary point P on the exit surface 6, are deflected by the lens dome 8 parallel to one another in a direction p. Thus, the exit surface 6 is projected to infinity according to optical laws. The same also applies to the differently colored chips G and B. A transformation of the exit surface 6 into a light distribution thus takes place in that a direction p is assigned to each point P of the exit surface by the converging lens 7 and its free-form lens dome 8, in which direction the light radiates with the brightness and color present at the point P, independently of the previous light ray directions.

Through this process, a precise color mixing also takes place at the same time, because only light rays originating from one of the chips or its mirror images pass through each point P; it is therefore not a homogeneous light bundle, but rather, as shown for red, a divergent bundle of individual red light rays, but also of the other colors, which fuse into a single “thick” light bundle approximately with the diameter of the converging lens in direction p due to the parallel direction by means of the converging lens 7. This applies to every point P of the exit surface 6, for all corresponding directions p, and for each of the colors R, G, and B to the same extent; an image of the exit surface 6 with the same characteristic is therefore projected congruently to infinity for each color, and for this reason a similarly mixed appearance in the mixed color appears to an observer from every viewing direction within the light distribution, without color spots or color fringing, because the light striking him always comes from all chips R, G, and B together and in the same way. The actual mixed color of the optical unit then results from control of the individual colors with different intensities, as is generally known.

The mirror-polished planes 4a, 4b extend from the light entry 2 of the light guide 3 to the exit surface 6 and diverge slightly symmetrically to the main axis h, as a result of which the divergence of the light rays is reduced somewhat in a known manner and their bundling is increased. The LED light source 1 is mirrored in an infinite manner at the planes 4a, 4b, so that a slightly curved arrangement of the light source mirror images results, which is effective or visible up to a limit angle of the light transmission in the light guide 3, the so-called aperture (A). Likewise, light rays ra, rb, rc etc., which are emitted by a chip R or its mirror image and pass either directly or as mirror images through the horizontal focal point Fh, and light rays rpa, rpb, rpc etc., which pass directly or as mirror images through an arbitrarily selectable point P of the exit surface 6, are drawn in. They are aligned parallel to one another by the converging lens in the direction of the main axis h or in direction p. The longer the light guide 3, the more mirror images are captured and the more uniform the resulting color mixing is. The same applies to all chips of other colors. The same applies to all chips of other colors.

A lens designed so simply cannot, of course, exhibit the properties of a corrected and rectified projection optical unit with an image plane; it is only approximately possible to obtain both sharp points P and simultaneously parallel light in direction p. An optimization with regard to the deviations results in a concavely curved exit surface 6 with all points P, shown as a dashed curve, and an increasingly divergent light emission the further the point P is removed from the main axis h. The drawn light rays through a point P are also not emitted as a compact light bundle in direction p, but rather already exhibit a small internal divergence originating from the size of the chips. In this respect, the rectangular exit surface is also not projected as a rectangle with sharp edges, but rather blurring and light fall-off towards the outside occur, as well as a distortion by the free-form lens dome 8 of the converging lens 7; in addition, the different brightness and light direction, which can still be influenced by shielding or design effects described later, have an effect.

Such distortions are irrelevant for the color-mixing quality as long as all colors are affected by them in the same way. In this context, it is of course also assumed that the refractive index of the optical material used depends little or almost not at all on the color or wavelength of the light colors used. This is the case with important transparent plastics and some technical glasses, so that no problems have become known therefrom. Typically, the optical unit is manufactured from a highly transparent plastic or a glass having a refractive index that is substantially independent of a wavelength of colored light colors, and is substantially free of light-scattering ingredients.

The projection of the non-uniformly bright exit surface provided with a light direction distribution through this free-form lens thus in no way results here in an equally bright rectangle with added-on light surfaces as in the already known application, but rather the overall coordinated light distribution is emitted.

However, since this is conceptually a sectional representation of the optical unit through the main axis h, these explanations also apply only to this sectional plane as a fundamental explanation. In fact, countless light rays run in all directions through the light guide and the converging lens, which makes a clear graphic representation practically impossible. Even in a spatially rotatable 3D representation on the computer, hardly anything can be seen; suitable data analysis is required.

A separate converging lens 7 is shown here. However, a one-piece optical unit, where the light guide 3 merges directly into the converging lens 7, is often advantageous, because in this way not only interface losses of two passage surfaces are avoided, but the converging lens also becomes smaller and a one-piece optical unit can be positioned much more easily; the exit surface 6 is then only virtually present at that position where the reflection planes 4a and 4b end, as shown for example in FIG. 3. However, a separate converging lens offers more design options, such as different optical materials and better lens correction options.

FIG. 1B represents the associated transverse view to FIG. 1A. It also shows the image that an observer sees looking through the exit surface 6 into the light guide 3. He sees in the center the LED light source 1 with the three chips R, G, and B within the light exit surface 1a, which are arranged in a horizontal line and exhibit the same size or the same vertical chip width c. The light exit surface 1a of the LED light source 1 mostly lies entirely within the entry surface 2, so that hardly any light is lost to the outside. Vertical lines are drawn on both sides, which represent the laterally delimiting reflecting planes 4a, 4b of the light guide 3, as well as all adjacent mirror images of the LED light source 1 at least up to the already mentioned circular boundary, which shows the aperture A or effectiveness limit. It can further be recognized, taking FIG. 1A into account, that only the middle chip G and its mirror images exhibit regular distances; the chips R and B and their mirror images form alternating pair arrangements which only on average exhibit the same distance as R, therefore it is advantageous to be able to mix as many mirror images as possible. This is the same phenomenon of achieving an average brightness in a large number of irregular arrangements, as described in the already known application; however, here it only occurs in the horizontal direction and is mixed horizontally by the geometric arrangement of the planes 4a and 4b.

In the vertical direction, on the other hand, nothing needs to be mixed if the chips R, G, and B are aligned horizontally, have the same chip width c and the same emission characteristics. To this end, imagine by analogy a classic converging lens over such an RGB LED, which produces three partially overlapping light disks in red, green, and blue in a horizontal arrangement on a nearby projection screen. In order to no longer be able to recognize colored disks, these must be completely mixed horizontally. However, this only succeeds if the disks have the same sizes and the same brightness course, otherwise this mixing produces certain horizontal color stripes, which would then nevertheless also have to be mixed vertically to eliminate them.

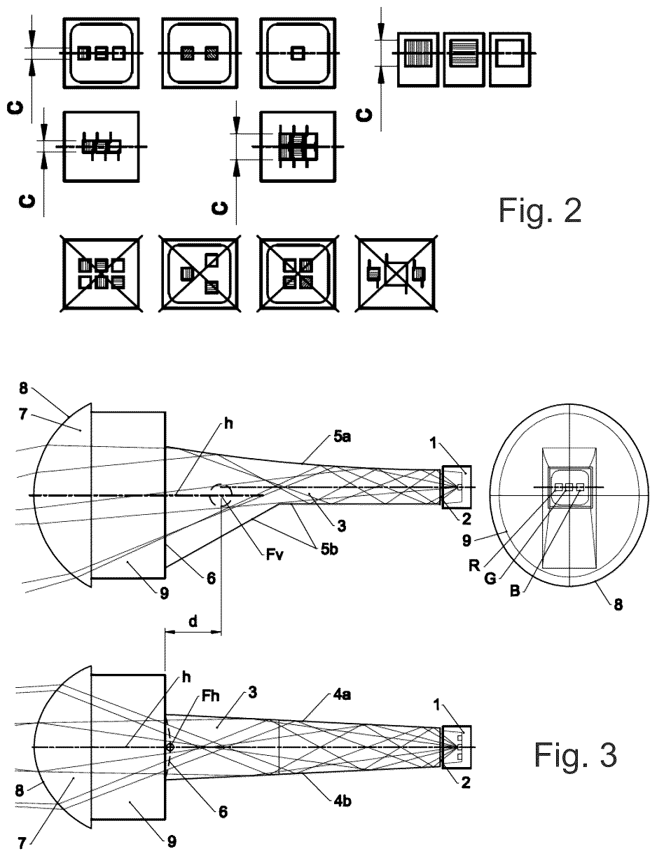

The already known application, as clearly recognizable in its FIGS. 1 and 2, assumes freely selectable chip positions, for example in a triangular arrangement, mostly with four electrical connections, which were still common at that time. In the meantime, however, the linear chip arrangement in RGB LEDs with 6 electrical connections for individual wiring and significant brightness and efficiency increases of the LEDs has become established, which are now also better suited for narrow-beam traffic display panels. In the data sheets of RGB LEDs, one often finds their light distribution curves for red, green, and blue, which appear as congruent in one direction and somewhat shifted against each other transversely thereto; this is precisely the effect as previously described, which would have to be mixed in the respective direction, but is irrelevant without an optical unit in front of it.

FIG. 2 shows some LED light sources 1 in top view. They are often available in different sizes, depending on the required light quantity. In the upper row, one sees an RGB LED, then a bicolor LED and a monochromatic LED, which indeed does not have to be mixed, but with the optical unit produces the same light distribution as the multi-colored LEDs. Next to them, so-called chip LEDs are arranged in a dense packing. Below them, equivalent embodiments in COB technology can be seen. Likewise, chips of the same size and color can be assembled into a larger arrangement and operated in the same way. The total chip width c and emission characteristic achieved therewith must then, however, again be the same for all colors; the optical unit for this must then also be designed accordingly enlarged. In the bottom row, chip arrangements are shown which do not form a horizontal arrangement with the same chip width c and can only be mixed with the already known system. This also applies to LEDs with a white chip which exhibits a strong blue-yellow-differing color emission and therefore requires all-round mixing. In principal, arbitrary colors can be selected and mixed, provided that the chips have identical dimensions and emission characteristics.

FIG. 3 shows in plan, front, and side elevation an embodiment of an illustrative optical unit for a display panel according to standard EN 12966. The alignment of the chips R, G, and B is horizontal. Their emitted light is represented in its course by means of individual example light rays. In the plan view, the boundary planes 4a, 4b, as well as their end can be seen, at whose position the now virtual curved exit surface 6 and thereon the horizontal focal point Fh of the converging lens 7 is located, which connects seamlessly in one piece. In this way, not only is the efficiency increased, but the necessary size of the lens dome 8 is also reduced, which in turn makes a smaller pixel grid possible. This also results in the possibility of forming a fastening zone 9, with the aid of which the entire optical unit can be positioned, oriented, and sealed in a device. It is shown here in simplified cylindrical form and is not involved in light shaping.

In the elevation view, the selected boundary surfaces 5a and 5b are visible in profile. The upper boundary surface 5a forms a slightly curved concave surface; it extends from the entry surface 2 to the virtual exit surface 6 and widens the light guide cross-section a little. The lower boundary surface 5b appears bent. The horizontal section indeed begins at the entry surface 2, but thus only extends over a partial region of the light guide 3 and then abruptly changes its direction forming an edge. The adjacent sloping section has little to do with the generation of the light distribution, but it clears the way for light rays which, reflected by the surface 5a, form the lower region of the light distribution. In addition, it influences the behavior of the optical unit in the event of incident sunlight from outside, which, however, is irrelevant for this application. In contrast to the already known optical unit, the connecting surfaces 5a, 5b can also be made shorter or longer than the light guide 3 without impairing the color mixing because precisely no mixing at all takes place in this direction.

The converging lens 7 in front is vertically less curved than horizontally. This produces a rather imprecise vertical focal spot Fv in the section, which lies by the dimension d behind the exit surface 6 with the horizontal focal point Fh; the lens dome 8 is thus a free-form surface. It appears as an upright oval. This is also recognizable in the side elevation and thus also from outside the display, and it is thus possible to infer the mixing system used. The fact that an imprecise focal spot Fv is formed here has to do not only with the design of the light distribution, but again with the directing of incident sunlight, which, however, is not the subject of this application.

The curved upper and bent lower boundary surface results in a virtual observer, located at the upper or lower end of the boundary surfaces 5a and 5b, respectively, and looking toward the light source, not getting to see the entire content of the light guide 3, in contrast to an observer in the central region, since the upper curvature or the lower bend respectively conceals a partial region of the direct or mirrored light rays; in particular, the direct view of the LED chips may not be possible, although each chip illuminates the entire exit surface 6 directly or indirectly. It follows from this that the brightness of the exit surface 6 in the present disclosure is not equally bright everywhere in comparison to the already known application, but rather forms a designable brightness gradient. For this reason as well, the chips must have vertically identical widths c and identical emission characteristics in order to be concealed in the same manner. The brightness distribution on the exit surface 6 must be identical for all colors; a single differently positioned chip would illuminate the exit surface differently in its color and thus cause color phenomena. It also follows therefrom that the connecting surfaces must run straight in the horizontal direction. Thus, every cross-section of the light guide 3 normal to the main axis h appears as a rectangle.

However, the vertical light distribution is not only a result of suitable covering of the light rays by the connecting surfaces in interaction with the converging lens and its free-form lens dome 8. This is because the covered light is not lost; it is mirrored to another location of the exit surface 6, whereby its original direction also changes. Thus, a specific distribution of the vertical light directions is also created in the exit surface, which likewise acts on the light distribution and can be smoothed or even emphasized by the lens dome 8. Only through the interaction of brightness and direction of the light rays can abrupt changes in brightness, such as a light-dark boundary, be produced, as is required here.

It appears plausible that the variety of design options for the upper and lower connecting surfaces 5a and 5b together with the lens dome elaboration do not allow an immediate prediction of their effect; for this purpose, an optimization of the geometry by means of computer simulation is indispensable.

The light distribution of the presently disclosed optical units is thus formed in the horizontal direction from the distance and expansion angle of the lateral reflection planes and the horizontal position of the focal point Fh on the exit surface 6 and in the vertical direction from the geometry of the vertical boundary surfaces 5a and 5b and a focal spot Fv or a varying focal length and the selected geometry of the converging lens 7. Thus, the light distribution is not dependent on a deviation from the rules of design through plane extensions of the light guide and supplementation of the light distribution through attached light surfaces, as described in the known application; the light distribution is achieved here directly without compromise between light distribution and color mixing and is thus of better quality.

The elevation view also shows the main axis h of the converging lens 7, which penetrates the focal spot Fv. It is mostly not identical to the axis of the light source 1. Independently thereof, a so-called optical axis, not shown, is also defined, which specifies the vertical alignment of the optical unit at which the lighting standards are met and which is important for the mounting or adjustability of the device suspension.

It should be noted that the color mixing and light distribution are also not achieved anywhere here by light-scattering elements or rough surfaces, as is mostly common, but only by crystal-clear material, the special geometry, mirror-polished surfaces, and lossless reflections via total internal reflection. Only in this way can the highest efficiency also be achieved. Naturally, it is nevertheless possible to overlay some surfaces or the lens dome locally with grooves, prisms, scattering structures, or roughness. However, because the system according to the present disclosure can be designed in more diverse ways than the already known system, such loss-increasing measures, corrections, and compromises are mostly avoidable.

So that the predefined course of the light distribution can be projected, it must be replicated as precisely as possible through suitable choice of all parameters. For this purpose, the light sources, the size and position of the entry and exit surface, the inclination of the two reflection planes 4a and 4b, the design of the connecting surfaces 5a and 5b, the length of the light guide 3, the focal point Fh and the focal spot Fv or the focal lengths and a focal length gradient of the converging lens 7 and its diameter must be coordinated with one another, and unavoidable light losses, such as light no longer captured by the converging lens or light radiated into irrelevant regions, must be accepted, and also unavoidable light losses through absorption and interface transition, as well as manufacturing tolerances and polishing defects must be taken into account; at the same time, the optical unit should have at least the mathematically required minimum brightness and best efficiency. It is obvious that such coordination of the geometry can only be carried out by means of computer simulation and multiple iteration steps and optimizations and much practical experience.

FIG. 4 shows the optical unit from FIG. 3 in an illustrative representation, with only a few example light rays which emerge from the lens dome 8 and radiate to infinity. If a projection screen is held in front of it, the achieved light distribution is depicted thereon, which can be represented in a known manner with curves of equal brightness within an angular grid as an isocandela diagram, or also as an image or also only as a table of values. Also visible are the cross-sections of the lens dome 8, shown in dashed lines, visible through horizontal and vertical sections through the main axis h.

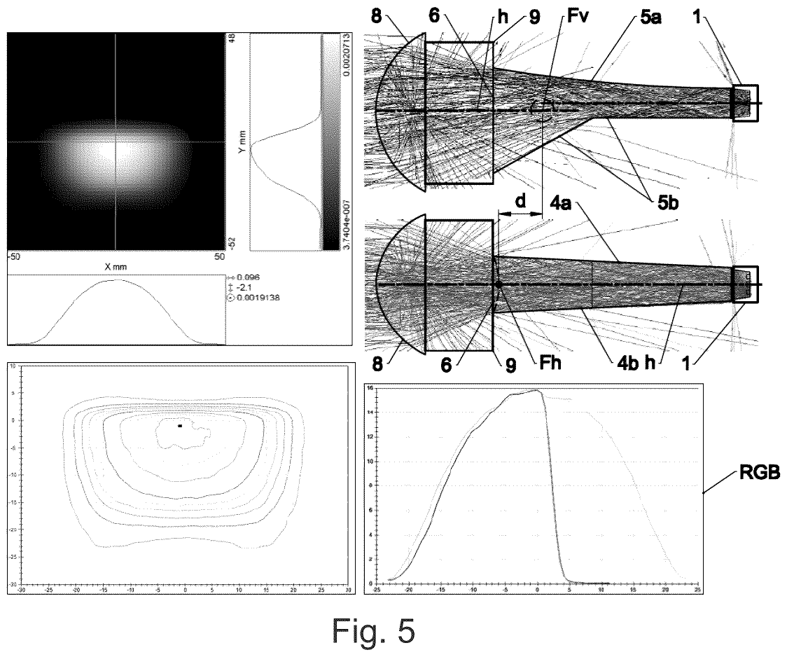

In FIG. 5, the simulation results of the described optical unit from FIG. 3 are directly represented to convey an impression thereof. The countless light rays themselves do not allow much to be recognized; in particular, one sees stray light emerging laterally from the gap between the LED light source 1 and the light guide 3, as well as light that is reflected back from the lens dome 8 according to Fresnel's law of refraction. It should be mentioned that each light ray possesses its own brightness and the recognizable quantity of light rays alone says nothing at all, because it is a mix of unimportant weak and significant strong light rays from all possible directions, which is mathematically processed only at the projection screen. At the top left, the result of the light distribution can be seen as a visual representation including horizontal and vertical sections through the distribution, below it the isocandela diagram, and next to it again a horizontal and vertical section through the light distribution through the main axis h. In this simulation, all chips R, G, and B shine with equal brightness.

The light simulation takes place by means of ray-tracing methods, wherein a freely selectable high number of light rays is generated according to a random principle, tracked physically/mathematically on its path through the optical system and projected onto a screen, wherein the light distribution obtained is converted back into a wide variety of light distribution graphics by statistical pixel evaluation, and wherein many characteristic values regarding efficiency and losses also result; adherence to and improvement of the target specifications can thus be continuously monitored during the work. Even with several million light rays, statistical fluctuations still occur, which manifest themselves through small differences in the generated distribution curves but are visually either not present at all or not perceptible. However, if these turn out to be significant, analyses and renewed simulation attempts must follow.

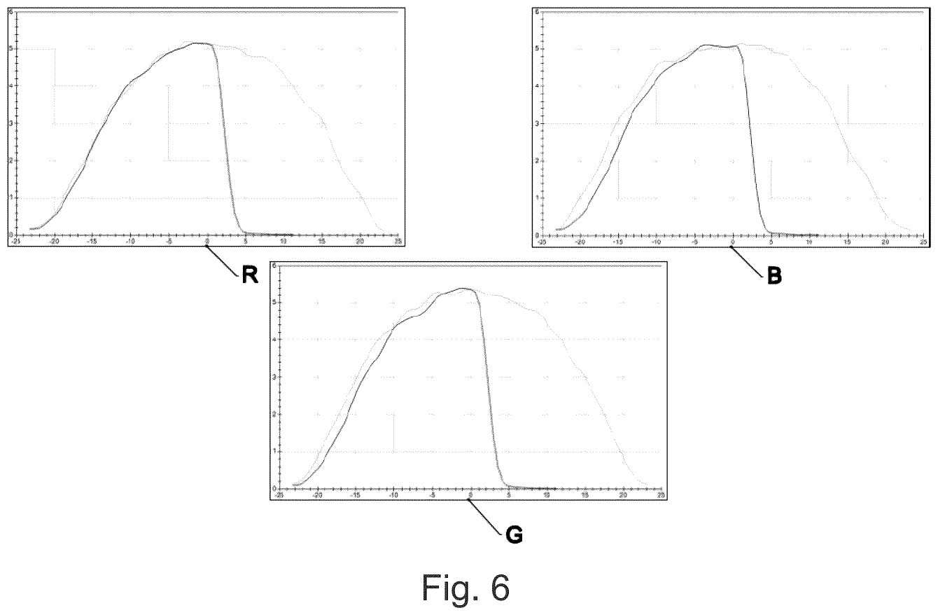

The proof of the excellent mixing quality on paper without presenting a prototype and practical demonstration is now provided in that the light distributions are calculated individually for each chip and the results are then compared with one another. If the light distribution is very similar, which can be determined, for example, by superimposing the results, then excellent mixing quality can be expected. FIG. 6 shows for this purpose the simulation results for the individual colors R, G, and B in cross-section diagrams. Great similarities to one another can be seen, but also the similarity to the overall distribution in FIG. 5 at the bottom right. The mixing thus seems to have succeeded very well. To be able to evaluate the statistical errors, it should be mentioned here that the geometric arrangement of the red chip R and the blue chip B in the optical unit is exactly mirror-symmetrical, which is why an identical result should actually be expected. As can be see, this does not quite apply, however; there are slight deviations from each other. Thus, the statistical inaccuracy of the simulation method also becomes visible in terms of magnitude and one can assume that the result as a whole is very good, because larger deviations than between the actually equivalent graphics R and B are not visible anywhere. Likewise, any other representations can of course also be simulated with each chip individually and compared with one another.

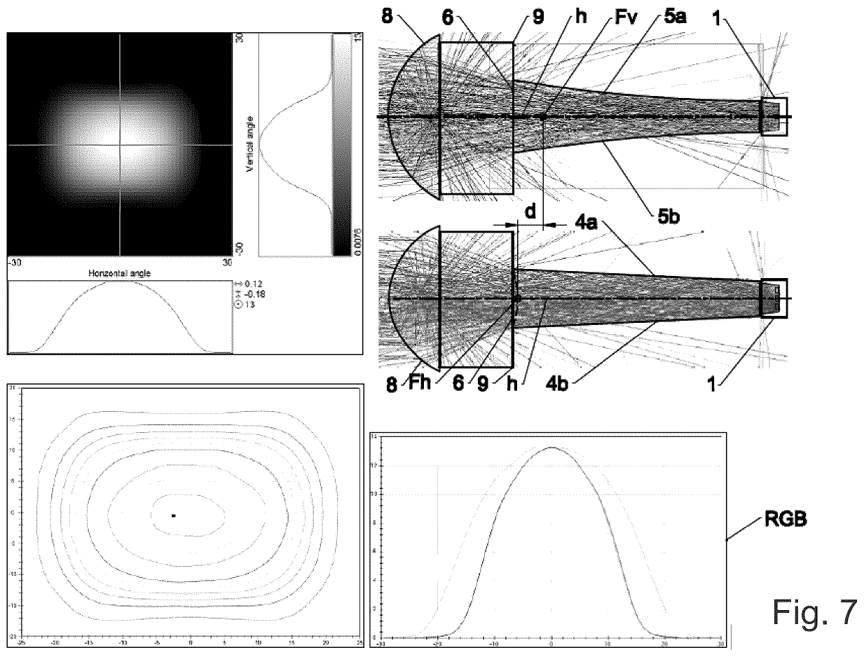

In FIG. 7, another simulated optical unit geometry according to the present disclosure is sketched in plan and elevation views and its light distribution, which is suitable, for example, for the already mentioned full-color flashlight because it produces a high bundling which, however, tapers off all around and can be rectangular or also square or round or oval as required. It is created from a funnel-like curved widening of the connecting surfaces 5a and 5b of the light guide 3.

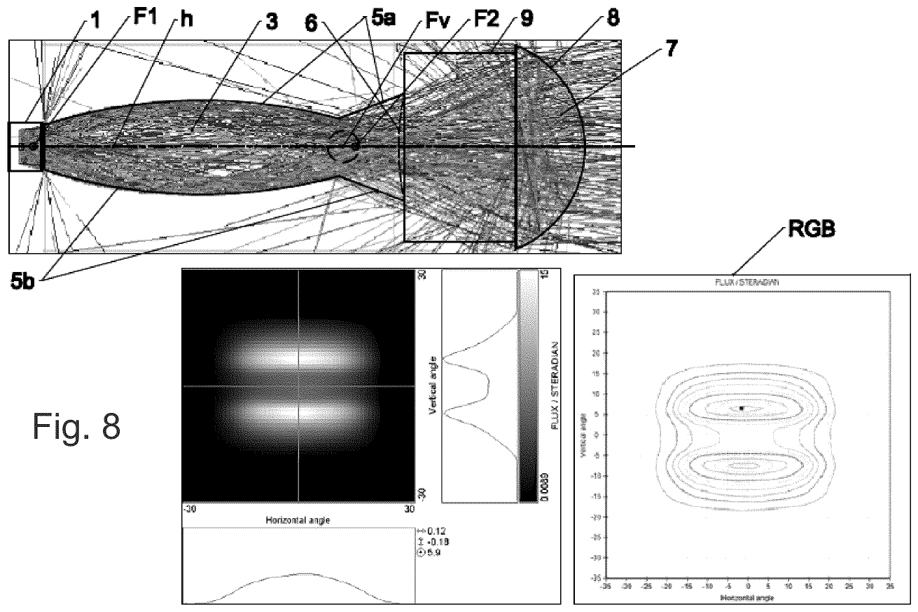

Through special designs of the connecting surfaces 5a and 5b, unforeseeable embodiments can be generated. For example, geometries that use sections of conic section curves and associated focal points in which, for example, the chips can come to lie are of particular interest. With these, for example, optical units can be built which emit two mixed light bundles at an angle to one another. FIG. 8 shows such an optical unit in elevation view. The connecting surfaces 5a and 5b have a very elongated elliptical geometry, in one focal point F1 of which the chips of the light source 1 lie, whose light is bundled toward the focal point F2 located near the converging lens 7, where its focal spot Fv is also located. The elliptical surfaces indeed bundle the light onto the second focal point F2; however, each of the surfaces produces its own somewhat divergent light bundle that is not axis-parallel and, together with the directly passing light, produces the represented light distribution with two bundles at an angle to one another. The elliptical connecting surfaces nevertheless produce a completely mixed light, which can be verified as described in FIG. 6. Here it is also shown that the exit surface 6 can exhibit not only different brightness, but also strongly different light directions.

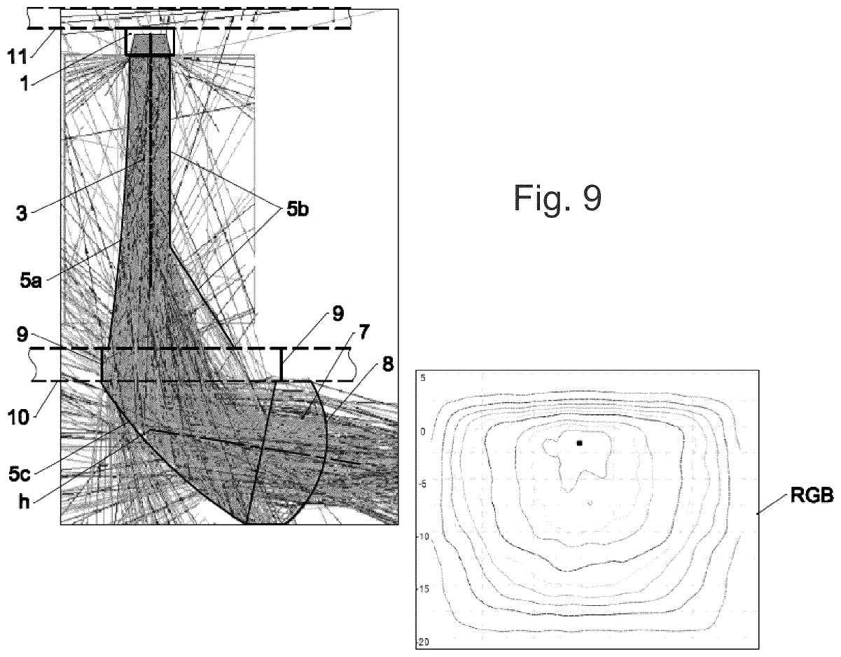

But optical units with internal complete light deflection can also be implemented, where, for example, the main axis is not perpendicular to the LEDs and their circuit board. FIG. 9 shows such an optical unit in elevation view. It can be used, for example, in road tunnels with a flat ceiling and low construction height; the housing is fastened lying flat on the ceiling and the optical units are arranged hanging in a grid that is greatly stretched in the direction of travel in order to offer the viewer a relatively less distorted representation of the symbols and texts. The device front 10, in which the optical units are mounted in the fastening region 9, is oriented largely horizontally, the circuit boards 11 are arranged parallel thereto as usual, and the optical unit protrudes little from the housing in order to avoid mutual shading. The light deflection takes place through total internal reflection at the mirror-polished surface 5c and radiates slightly downward into the tunnel. A consideration of solar rays is not necessary here; the brightness can also turn out much lower and the light distribution RGB produced can be adapted to the situation; the color mixing also works with this angling. The horizontal mounting allows arbitrarily elongated displays, which in most cases looks much better than a standard display of equally low construction, in particular when one is already relatively close to it.

The many light rays around the optical units shown are very weak, multi-reflected and refracted leakage light rays, for in these basic simulations only the essential optical surfaces but no complete components and also no fastenings in the device front were constructed. The light ray images included in FIGS. 5, 7, 8, and 9, as well as graphics and diagrams in FIGS. 4 to 9, originate from real simulations with which the mode of operation of this application and its color-mixing quality were verified.

The presented color-mixing optical unit is particularly well-suited whenever a cosine-like light course is required in one direction and, transversely thereto, a very individual light course with jumps, ramps, light-dark boundaries, deflections, light out-couplings, for example for sensors, etc., is required.

However, the free design of the connecting surfaces 5a and 5b can also be used to embodiment the penetration of external light from outside, such as sunlight, and thereby enable retroreflection or absorption. But technological influencing of the injection molding process in the manufacture of plastic optical units or mounting processes is also possible within limits here.

In principle, the optical unit is also scalable and thus adaptable to certain higher light outputs of high-power LEDs. However, it is likewise possible to arrange a plurality of identical optical units close to one another and to control them in the same way in order to obtain a more powerful system, which is mostly much more cost-effective.

Otherwise, all embodiments mentioned in the already known application are also possible, such as combinations of arbitrary colors and also redundant identical colors with safety switching in the event of LED failure or color change for safety-relevant products, but also effect lights and stage lighting. Likewise, in the case of displays, combinations of full-color-capable and monochromatic regions, for example for graphic representations and text fields with the same light distribution, are possible. The optical units also do not have to form pixel grids, but can be positioned in any individual arrangement, for example for symbol representations such as digits, letters, red circle, and red triangle, and be equipped with circuit boards of the same LED positioning.

In the description and claims, the terms “substantially” or “essentially” mean a deviation of up to 10% of the specified value, if physically possible, both downwards and upwards, otherwise only in the meaningful direction; in the case of degree specifications (angle and temperature), this means ±10°.

The characteristics and variants specified for the individual embodiments and examples disclosed herein may be freely combined with those of the other examples and embodiments and may in particular be used to characterize the heat exchanger of the present disclosure in the claims without necessarily entraining the other details of the respective embodiment or the respective example.

### LISTING OF REFERENCE NUMERALS

1 LED light source
2 Light entry surface
3 Light guide
4a, 4b Reflection planes
5a, 5b Connecting surfaces
5c total-reflecting surface
6 Light exit surface
7 Converging lens
8,8a Lens dome
9,9a Peripheral region of converging lens
10 Device front
11 Circuit boards
c LED width
Fh First focal point
Fv Focal spot
h main axis, optical axis

16. A color-mixing collecting optical unit having a main axis, comprising:
an LED light source including a plurality of LED chips, wherein the LED chips are disposed in a linear arrangement and have substantially identical widths and substantially identical emission characteristics;
a light guide having a light entry surface arranged directly in front of the LED light source that is configured to capture and transmit light emitted by the LED light source; and
a converging lens succeeding the light guide having a mirror-polished lens dome; wherein
the light guide is delimited on each side by a pair of symmetrically-designed and mirror-polished reflection planes aligned perpendicular to the linear arrangement of LED chips such that a distance between the side reflection planes is constant or gradually increasing in a direction of the converging lens; the light guide is further delimited by a pair of mirror-polished connecting surfaces that are transverse to the pair of side reflection planes and that meet the side reflection planes forming sharp edges; and where ends of the side reflection planes define an exit surface of the light guide; and
the converging lens has a first focal point in cross-section in a direction of the linear arrangement of the LED chips, the first focal point being on the exit surface of the light guide; and the converging lens has either another distinct focal point, or no other distinct focal point, or a focal spot that is transverse to the first focal point; such that the mirror-polished lens dome represents a free-form surface.

17. The color-mixing collecting optical unit according to claim 16, wherein the optical unit is manufactured from a highly transparent plastic or a glass having a refractive index that is substantially independent of a wavelength of colored light colors, and is substantially free of light-scattering ingredients.

18. The color-mixing collecting optical unit according to claim 16, wherein the LED light source includes RGB LEDs, two-color LEDs, monochromatic LEDs, or chip LEDs in any number and color.

19. The color-mixing collecting optical unit according to claim 18, wherein the LED light source includes one or more Surface-Mounted Device LEDs (SMD LEDs) and/or COB LEDs (Chip-On-Board LEDs).

20. The color-mixing collecting optical unit according to claim 16, wherein a length of the light guide is at least a multiple of a diameter of the light entry surface, and as the length of the light guide increases a number of effective mirror images of the LED light source created by the side reflection planes increases, and thus a color-mixing quality of the optical unit increases in a predictable manner.

21. The color-mixing collecting optical unit according to claim 16, wherein every cross-section of the light guide perpendicular to the main axis represents a rectangle.

22. The color-mixing collecting optical unit according to claim 16, wherein the pair of connecting surfaces are curved, angled, stepped, or shortened, or lengthened with respect to a length of the side reflection planes in a direction of the main axis of the optical unit.

23. The color-mixing collecting optical unit according to claim 16, wherein the light guide merges with the converging lens to form a single unit, and the exit surface of the light guide is therefore a virtual exit surface.

24. The color-mixing collecting optical unit according to claim 16, wherein the converging lens includes a peripheral region that is not involved in light shaping and serves for holding, orienting, and/or sealing the converging lens, or the entire optical unit, in a display.

25. The color-mixing collecting optical unit according to claim 16, wherein a geometry, a light direction, and a brightness gradient on the exit surface are projected to infinity in an upside-down manner and are modified by the lens dome of the converging lens, to directly form a desired light distribution.

26. The color-mixing collecting optical unit according to claim 16, wherein the linear arrangement of the LED chips is a horizontally-oriented linear arrangement.

27. The color-mixing collecting optical unit according to claim 26, wherein the optical unit is configured to be used in a variable message sign display.

28. The color-mixing collecting optical unit according to claim 27, wherein both a size of the exit surface in the direction of the linear arrangement of the LED chips and the distance of the first focal point from the lens dome are selected so that the optical unit generates a cosine-like light distribution course in a horizontal direction.

29. The color-mixing collecting optical unit according to claim 26, wherein a free-form design of the lens dome in combination with a design of the pair of connecting surfaces produces a desired light distribution in a transverse direction, without additional measures.

30. The color-mixing collecting optical unit according to claim 16, wherein the pair of connecting surfaces include elliptical, hyperbolic, or parabolic section courses, and the LED chips are arranged in a focal point of the converging lens.

31. The color-mixing collecting optical unit according to claim 16, further comprising an additional mirror-polished total-reflecting surface, wherein the optical unit is configured so that at least a portion of the light emitted by the LED light source is deflected in the transverse direction by the mirror-polished total-reflecting surface.

32. The color-mixing collecting optical unit according to claim 16, wherein at least one of the lens dome or the pair of connecting surfaces define locally-limited grooves, prisms, scattering structures, or roughness.
